(19) United States
(12) Patent Application Publication
(10) Pub. No.: US 2013/0346865 A1
(43) Pub. Date: Dec. 26, 2013

(54) DYNAMIC WALLPAPER OF MOBILE SYSTEMS

(71) Applicant: Via Technologies, Inc., New Taipei City (TW)

(72) Inventors: Cheng-Cheng YUAN, Shenzhen (CN); Su-Jun XU, Shenzhen (CN)

(21) Appl. No.: 13/926,699

(22) Filed: Jun. 25, 2013

(30) Foreign Application Priority Data
Jun. 25, 2012 (CN) 201210213818.2

(51) Int. Cl. G06F 3/0484

(52) U.S. Cl. CPC G06F 3/0484
USPC 715/720

(57) ABSTRACT

An operating method and device for showing dynamic wallpapers in mobile systems are provided. In one aspect, the disclosed method includes the steps of: displaying a selected video as the dynamic wallpaper; shrinking the display region of the dynamic wallpaper if a user inputs a shrinking command; and expanding the display region of the dynamic wallpaper if a user inputs an expanding command. In another aspect, the disclosed method includes the steps of creating a new display window for new video playback, wherein the dynamic wallpaper is paused when the new video is under a playback operation. A user may control the dynamic wallpaper and the new display window playing the new video to be shrunk, expanded, and/or moved by touching a screen with different gestures.

### CROSS REFERENCE TO RELATED APPLICATIONS

This Application claims priority of China Patent Application No. 201210213818.2, filed on Jun. 25, 2012, the entirety of which is incorporated by reference herein.

### BACKGROUND OF THE INVENTION

1. Field of the Invention

The present invention relates to a wallpaper shown on an electronic device, and more particularly, to a dynamic wallpaper displaying method for a mobile system.

2. Description of the Related Art

Mobile phones, tablet PCs and other mobile systems have been widely used in our daily lives and works. Since these systems have the characteristics of being thin, light and low power consumption, the ability for information processing is not as good as a desktop computer or other powerful systems, and many functions may be discarded. For example, the mobile systems can play video or other multimedia files on their screen, but the mobile systems can only play still images as wallpapers. That is, dynamic wallpapers cannot be implemented on mobile systems by means of video playbacks.

Therefore, it is desirable for a mobile system with limited hardware resources to play video as dynamic wallpapers. The dynamic wallpaper provides users with rich and colorful visual effects when using the mobile systems.

### BRIEF SUMMARY OF THE INVENTION

In one embodiment, a dynamic wallpaper displaying method for a mobile system is provided. The method comprises the steps of: selecting a video by a user; and playing the video as a dynamic wallpaper of the mobile system, wherein audio associated with the video is muted when the selected video is played as the dynamic wallpaper.

In the above embodiment, the dynamic wallpaper is displayed in full screen.

In the above embodiment, the method comprises a step of shrinking a display region of the dynamic wallpaper when the user inputs a shrinking command; and expanding the display region of the dynamic wallpaper when the user inputs an expanding command.

In another embodiments, a mobile system that is capable of playing a video serving as dynamic wallpaper is provided. The mobile system comprises: a screen; a non-volatile memory, storing control codes of the mobile system; a microprocessor, operating the control codes to execute the steps of: playing a video selected by a user for playback as a dynamic wallpaper on the screen of the mobile system; and muting audio associated with the selected video when the selected video is played as the dynamic wallpaper.

In the above embodiment, the dynamic wallpaper is displayed in full screen.

In the above embodiment, the microprocessor operates the control codes to shrink a display region of the dynamic wallpaper when the user inputs a shrinking command; and to expand the display region of the dynamic wallpaper when the user inputs an expanding command.

In the above embodiment, the microprocessor operates the control codes to create a new display window for playing a new video and the video of the dynamic wallpaper has been paused when the new video is played.

In the above embodiment, the microprocessor operates the control codes to shrink, expand or move the new display window.

In the above embodiment, the method further comprises a method for displaying a new video when the dynamic wallpaper is displayed, the method comprising the steps of: pausing video playback of the dynamic wallpaper; showing a notification message to inform a user that video playback of the dynamic wallpaper has been paused; and playing a selected video in a new display window, wherein the new display window is displayed on the dynamic wallpaper.

In the above embodiment, the dynamic wallpaper is displayed in full screen.

In the above embodiment, the method comprises a step of shrinking a display region of the dynamic wallpaper when the user inputs a shrinking command; and expanding the display region of the dynamic wallpaper when the user inputs an expanding command.

In the above embodiment, the method comprises a step of shrinking the new display window when the user inputs a shrinking command; and expanding the new display region window when the user inputs an expanding command.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A shows a exemplary diagram of a dynamic wallpaper on a mobile system according to an embodiment of the invention.

FIG. 1B shows the variations of the dynamic wallpaper 100 after a period of time.

FIG. 2A depicts a schematic diagram showing a new display window created for displaying another video when the dynamic wallpaper is activated.

FIG. 2B depicts a schematic diagram showing an expanded window of FIG. 2A.

FIG. 2C is a schematic diagram showing how to modify the situation when the right side of the expanded window exceeds the right margin of the screen.

FIG. 2D depicts a schematic diagram showing a user moves the window when the dynamic wallpaper is activated.

FIG. 3A depicts a shrinking operation of the dynamic wallpaper.

FIG. 3B shows a diagram of shrunk dynamic wallpaper.

FIG. 3C depicts a schematic diagram where the user expands the new display window via a gesture.

FIG. 3D shows a diagram of the new display window of FIG. 3C after expansion

FIG. 3E shows a diagram of the new display window of FIG. 3D after horizontal expansion.

FIG. 4 shows a functional block diagram of the mobile system according to an embodiment of the invention.

FIGS. 5A and 5B show a flowchart of an operation method of the dynamic wallpaper according to an embodiment of the invention.

FIGS. 6A and 6B show a flow chart for creating a new display window to play another video when the dynamic wallpaper is activated according to an embodiment of the invention.

### DETAILED DESCRIPTION OF THE INVENTION

The following descriptions show embodiments of carrying out the invention. This description is made for the purpose of illustrating the general principles of the invention and should not be taken in a limiting sense. The scope of the invention is best determined by reference to the appended claims.

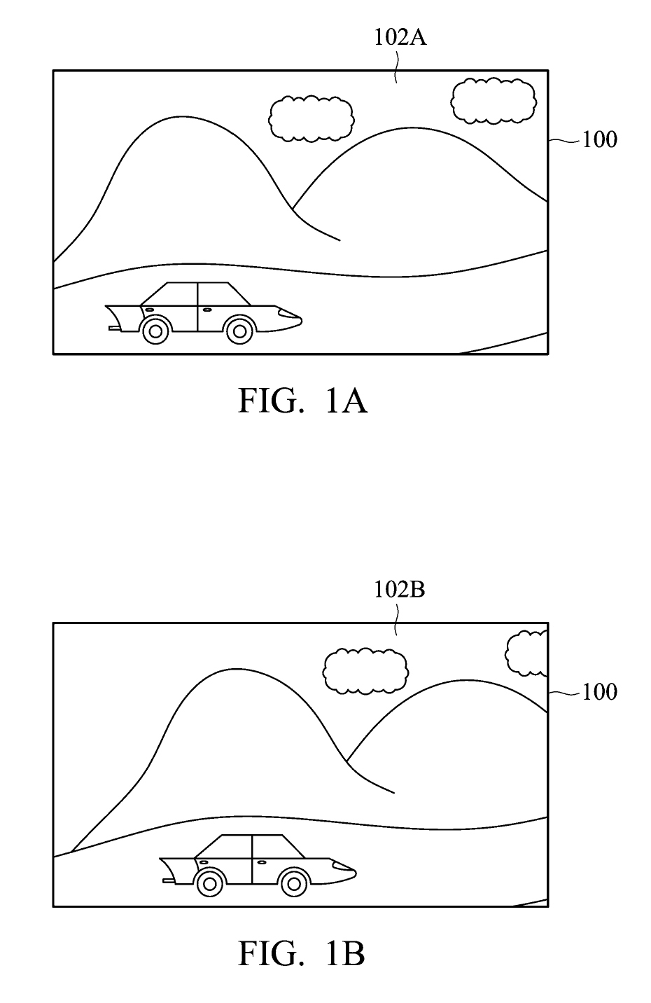

Please refer to FIG. 1A, which shows an exemplary diagram of a dynamic wallpaper displayed on a mobile system according to an embodiment of the invention. The dynamic wallpaper 100 displays a window 102A displaying a video. FIG. 1B shows the variations of the dynamic wallpaper 100 after a period of time. For example, compared with the windows 102A, the car in the window 102B moves to right a lot, and the cloud in the window 102A moves left a little bit. Notably, the video played in FIG. 1A and FIG. 1B may be input to the mobile system via the user or may be a default video stored by the manufacture inside the mobile system. To a person having ordinary skills in the art, a graphic user interface instructing the user to input video or audio files may be designed for the conventional mobile systems. Furthermore, the input video/audio files may be recorded by video recorders or mobile devices. In other embodiments, the video/audio files are received from other storage devices, such as a USB card, or SD card. In one embodiment, those skilled in the art may design an interface for a user to select video/audio files from the mobile devices, wherein the selected one is used for the dynamic wallpaper playback.

In one embodiment, when the function of the dynamic wallpaper 100 is activated, the mobile system may play the video but muting associated audio to save power and prevent the user from being affected by the audio playback when executing other operations. Furthermore, in another embodiment, the mobile system allows the user to play the audio associated with the video as the dynamic wallpaper playing currently. In yet another embodiment, the video information may be retrieved from video files with any format, such as an AVI, MPEG, MOV, ASF, or RM format or the like. In fact, any video file that may be recognized by the mobile system is able to be applied to the invention. In one embodiment, if the resolution of the video file is higher than the resolution of the screen of the mobile system, the video file is played with the highest resolution of the mobile system.

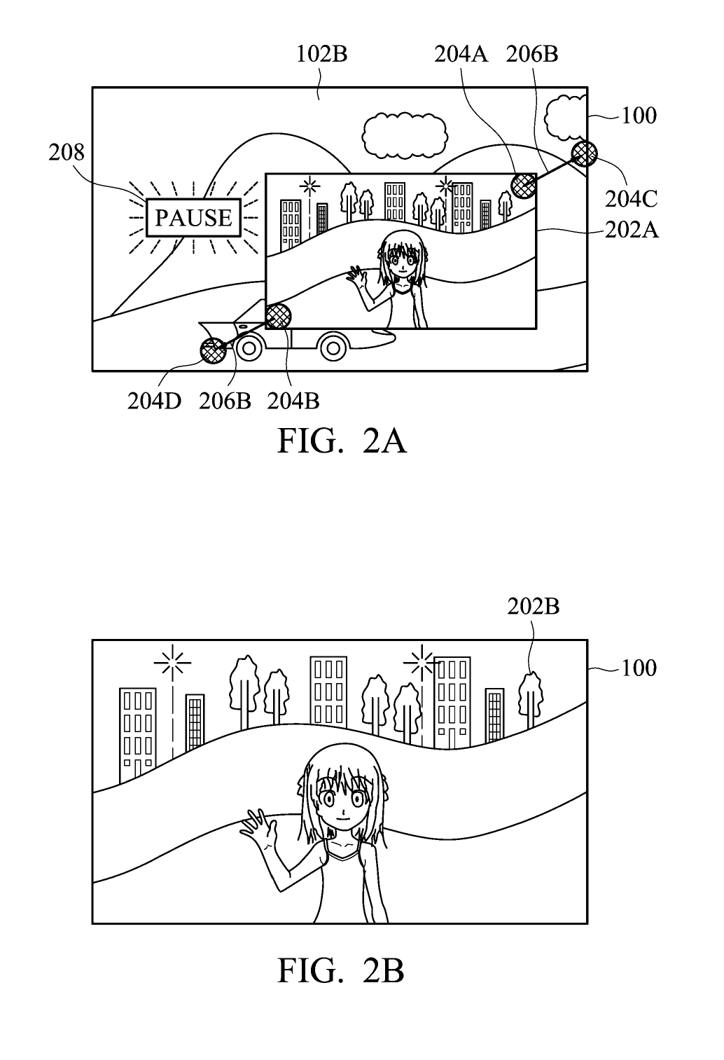

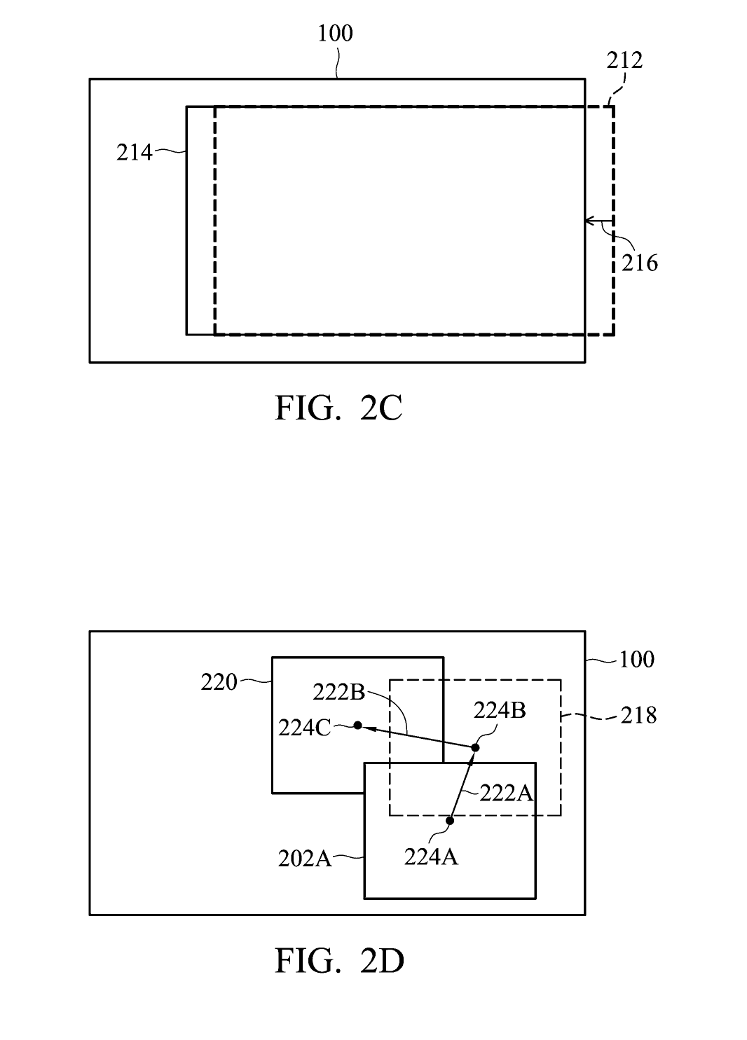

Please refer to FIG. 2A, which depicts an exemplary diagram showing a window created for displaying another new video when the dynamic wallpaper function is executing. In FIG. 2A, the newly created window plays video in the window 202A. Since the hardware resources of the mobile system are limited, the window 102B pauses video playback, i.e., the screen of the window 102B is paused when the window 202A plays new video. Thus, hardware resources, such as a CODEC, are all bound to play the new video shown in the window 202A, and currently frozen window 102B does not cause user's vision in clutter. Furthermore, in order to notify the user that the window 102B playing the dynamic wallpaper has been paused now, an indication message “PAUSE” 208 may be shown on the screen of the mobile phone system. Once the user closes the window 202A, the indication message 208 may be withdrawn. Although the embodiment is illustrated with the message “PAUSE”, those skilled in the art may use any word, graphics term or message to replace the message 208 to inform the user that the dynamic wallpaper 100 has been paused. Of course, the dynamic wallpaper may be directly paused without showing any notification message. Any ordinary person having skills in the art may vary or modify the disclosed embodiments as requirements of his/her practical applications.

FIG. 2A depicts a schematic diagram showing a new display window created for displaying another new video when the dynamic wallpaper function has been activated. Since the screen size of the mobile system is not large enough, the user may expand the window 202A when the window 202A is too small for viewing. In FIG. 2A, the user may use two fingers to touch the screen at the positions 204A and 204B and then his/her fingers may move outwardly to form an expanding gesture, wherein the screen displays frozen dynamic wallpaper 100 now. For example, the expanding gesture is formed when one finger is moved from the position 204A to the position 204C along the direction shown by arrow 206A and another finger is moved from the position 204B to the position 204D along the direction shown by arrow 206B. The screen of the mobile system detects two fingers' movements and calculates coordinates before movements, i.e., the coordinates of the positions 204A and 204B, and also coordinates after movements, i.e., the coordinates of the positions 204C and 204D. Then, the mobile system calculates an expanding ratio according to the coordinates of the four positions so as to expand the window 202A according to the expanding ratio. Finally, the video is played in the expanded window 202A again. For example, when the user inputs an expanding instruction via the input window in FIG. 2A, the window 202A is then expanded as the window 202B in FIG. 2B.

In one embodiment, the calculation of the expanding ratio can be determined according to a ratio between lengths before and after movements. The length before movement may be the length between the positions 204A and 204B, and the length after movement may be the length between the positions 204C and 204D. Furthermore, the center of the positions 204A and 204B, which may be acquired according to the coordinates of the positions 204A, may be served as the center of the window 202B. In one embodiment, the calculation of the expanding ratio may be determined according to a ratio of the X-axis and a ratio of the Y-axis. The ratio of the X-axis may be determined according to a projection length between the positions 204A and 204B on the X-axis and a projection length between the positions 204C and 204D on the X-axis. Similarly, the ratio of the Y-axis may be determined according to a projection length between the positions 204A and 204B on the Y-axis and a projection length between the positions 204C and 204D on the Y-axis. One skilled in the art may use other methods to calculate the expanding ratio of the window 202A. If the expanding ratio is too large, the window 202A may be expanded to full screen for video playback. In one embodiment, if only one side of the expanded window 202A exceeds the boundary of the screen, this side of the expanded window 202A is cut along the edge of the screen such that the expanded window 202A is not out of the screen. For example, in FIG. 2C, when the window 202A is expanded as shown by window 202C, the mobile system detects the right side of the window 202C exceeds the right edge of the screen, such as the dashed frame 212. The dashed frame 212 is shifted to the left along the arrow 216 until the right side of the dashed frame 212 meets along the right edge of the screen. The calibrated frame is shown as the frame 214. Thus, a user may see the whole screen of the played video.

FIG. 2D depicts a schematic diagram showing a user moving the window when the dynamic wallpaper is activated. When the user moves the window 202A, the video playback in the window 202A may be paused, wherein the boundary of the window 202A is shown by the dashed line to indicate the movement. For example, the dashed frame 218 is moved from the position 224A (the center of the window 202A) to the position 224B (the center of the dashed frame 218) along the direction of the arrow 222A. This may help the user to determine the position of the window for placement. When the user determines a new position for placing the window, the mobile system automatically restores the video playback in the window 202A. In one embodiment, when the user moves the window, only the dashed frame 218 is shown to inform the user to where the dashed frame 218 is moved. In another embodiment, the window 202A may show a frozen frame accompanied with user's movements. Those skilled in the art can modify or change the described embodiment according to applications.

Note that when the user moves the window, the user may use a single finger to move the window. The mobile system determines the movement of the dashed frame 218 according to the moving direction of the user's finger. In other words, the mobile system adjusts the movement of the center of the dashed frame 218 according to the movement of the user's finger.

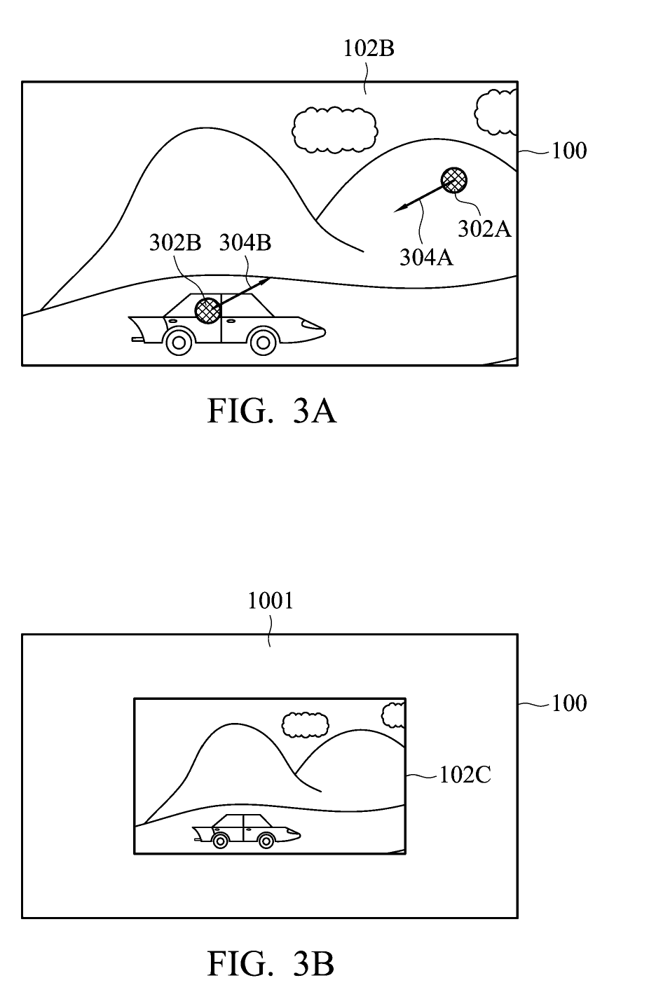

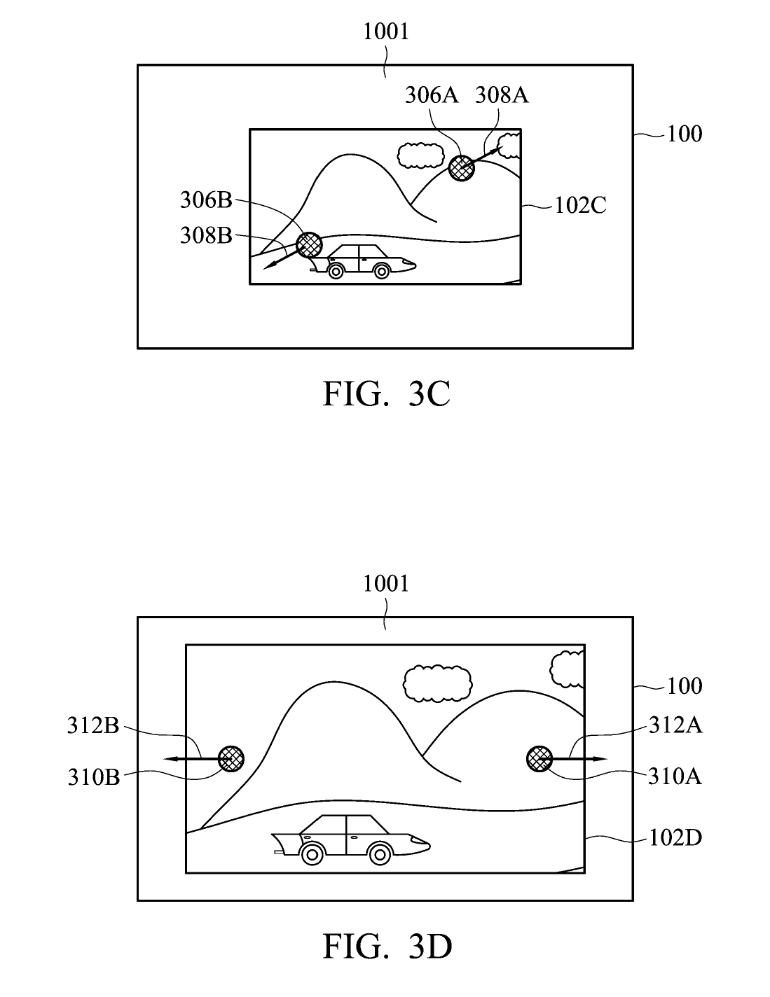

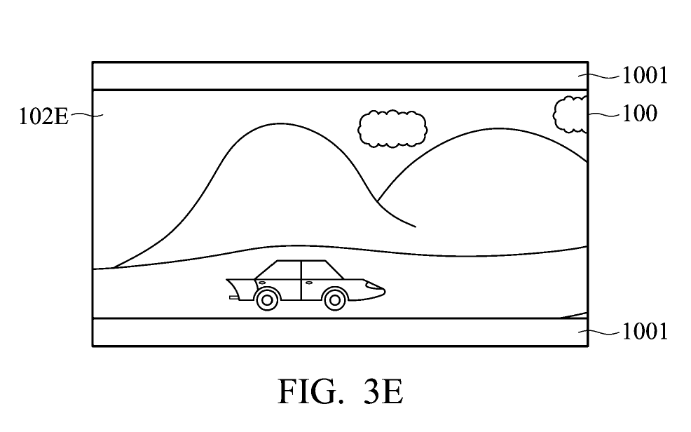

The invention provides the shrinking/expanding functions for the window playing video on the dynamic wallpaper, and also the shrinking/expanding functions of the dynamic wallpaper itself. Please refer to FIG. 3A. FIG. 3A depicts a shrinking/expanding operation of the dynamic wallpaper. In FIG. 3A, two fingers of a user are placed on the positions 302A and 302B to inform the mobile system to execute a shrinking operation to the dynamic wallpaper 100 according to movements of the arrows 304A and 304B generated from user's gesture. When the mobile system detects a shrinking ratio, the video of the dynamic wallpaper is displayed in window 102C, such as that shown in FIG. 3B. Then, if the user feels the size of the window 102C is too small, the user may use two fingers to touch the screen so as to expand the window 102C. In FIG. 3C, the user's two fingers are placed at positions 306A and 306B to inform the mobile system to slightly expand the window 102C (that is why the lengths of the arrows 308A and 308B are not too long). When the mobile system determines the expanding ratio, the window 102C is expanded as the window 102D in FIG. 3D. If the user wants to expand the dynamic wallpaper in one direction, such as X-axis (horizontal axis or direction), the user's fingers can touch the positions of 310A and 310B and moves according to arrows 312A and 312B so as to inform the mobile system to expand the window 102D along the horizontal direction. When the mobile system determines the expanding ratio, the window 102D is expanded to window 102E shown in FIG. 3E.

Note that the window shrinking operation is similar to the window expanding operation but the only difference is an opposite gesture. Furthermore, the calculation of the shrinking ratio is the same as the expanding ratio but the only difference is lengths before/after movements are opposite. That is, the length after the shrinking operation is shorter than that before the shrinking operation, while the length after the expanding operation is larger than that before the expanding operation. Note that there is blank area 1001 that is not covered by the window 102C exists in FIGS. 3B-3E. In FIG. 3B, the blank area 1001 exists around the window 102C and the blank area 1001 exists only in areas upper and bottom of the window 102C in FIG. 3E. The blank area may remain blank or display another image as the wallpaper according user settings. One skilled in the art may modify the described embodiment according to practical applications. Furthermore, if the resolution of the video file of the dynamic wallpaper is higher than the resolution of the screen of the mobile system, the video file of the dynamic wallpaper is played with the highest resolution of the mobile system.

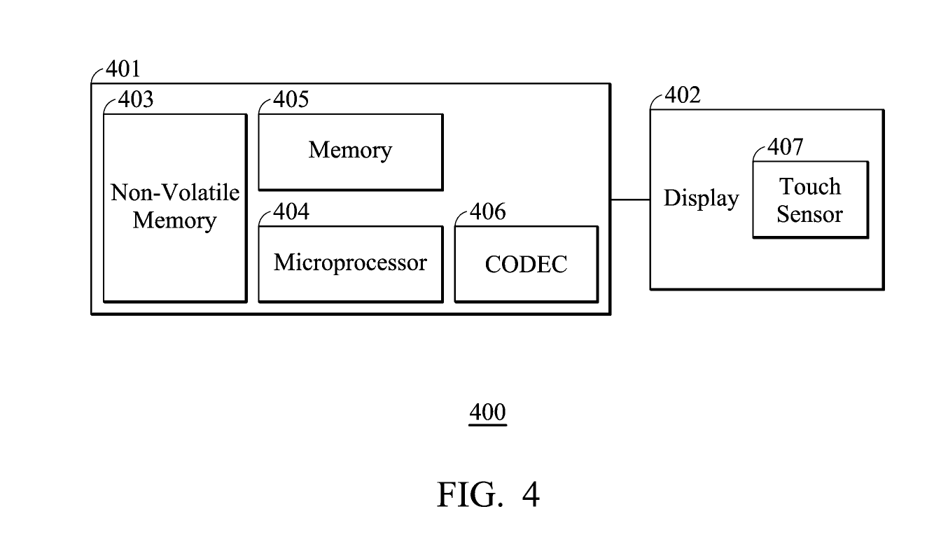

Please refer to FIG. 4. FIG. 4 shows a function block diagram of the mobile system according to an embodiment of the invention. The mobile system 400 shown in FIG. 4 comprises a motherboard 401 and a screen 402 coupled to the motherboard 401, wherein the motherboard 401 transmits the video to be displayed to the screen 402. The motherboard 401 further comprises a non-volatile memory 403, a microprocessor 404, a memory 405 and a CODEC 406 and the screen 402 comprises one touch sensor 407. The non-volatile memory 403 stores codes required by the mobile system and/or the microprocessor 404 to execute operations, such as reading instructions from users, calculating a shrinking/expanding ratio, and performing dynamic wallpaper operations (shrinking/expanding, displaying/canceling an indication message (PAUSE)). The non-volatile memory may further store default videos and/or images of the mobile system. The microprocessor 404 is the core of the mobile system that executes the codes stored in the non-volatile memory 403 to control the mobile system to execute operations indicated by its user. The operations comprise showing a user interface to inform the user to input the video required by the dynamic wallpaper, calculating the shrinking/expanding ratios and movements, calculating the center point of the window after shrinks, expansions or movements, adjusting the window size/placement if the area is expanded or moved exceeding the margin of the screen, pausing or resuming the video of the dynamic wallpaper, or transmitting the video to the CODEC for decoding and playback. The memory 405 may store temporal data of the mobile system, including those codes required by the microprocessor 404, images, videos, values for calculating the expanding/shrinking ratio and other operations. The CODEC 406 acts as a decoder to decode and transmits video data to the screen 406 for playback, while the audio data are decoded and transmitted to the speaker of the mobile system (not shown in FIG. 4). The screen 402 not only displays images and videos, but also comprises a touch sensor 407 to detect a user's touches, such as the positions of fingers, and gestures (movements). The detected touch positions and gestures are transmitted to the microprocessor for further processing. Note that the video data is usually large, such that the invention introduces the hardware CODEC 406 for the sake of accelerating video decoding processing. When other modules of the mobile system needs the CODEC 406 for some operations, such as video playback of the new window 202A, applications associated with the dynamic wallpaper 100 releases controls of the CODEC 406. When none of the modules needs the CODEC 406, applications associated with the dynamic wallpaper 100 catches controls of CODEC 406 back so as to continue video playback. In other embodiments, the CODEC 406 and the microprocessor 404 may be integrated in an identical chip.

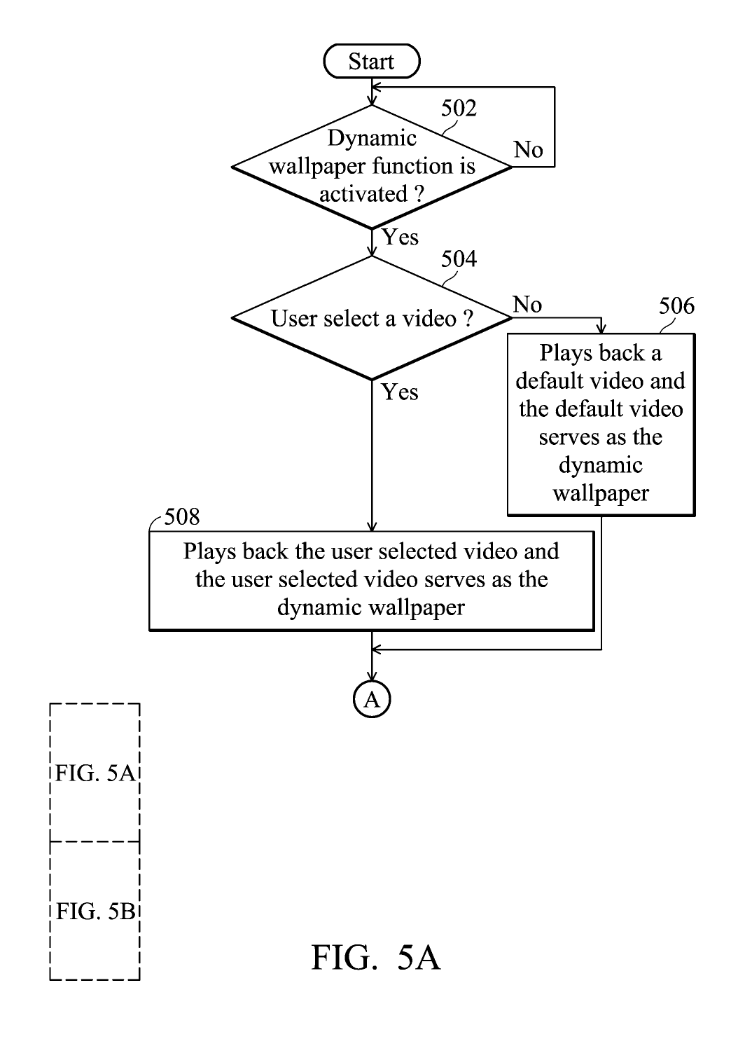

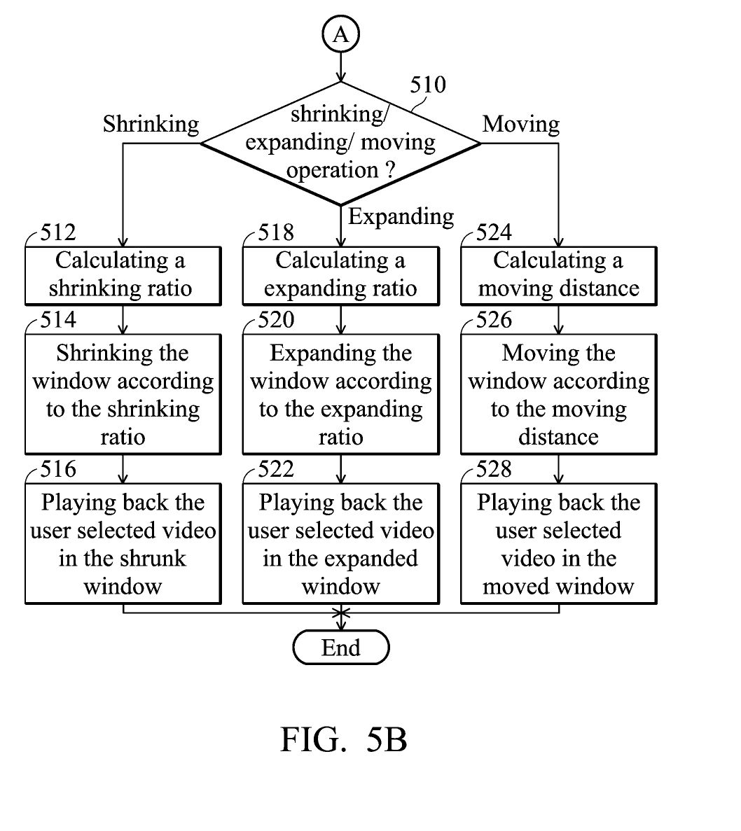

FIGS. 5A and 5B illustrate the operation procedure of the dynamic wallpaper of the invention. When the user activates the dynamic wallpaper function (step S502), the mobile system informs the user to select a video for playback (step S504). If the user does not select a video or the selected video is lost, the mobile system plays a default video as the dynamic wallpaper (step S506). If the user selects a video and it is available, the selected one is then played as the dynamic wallpaper (step S508). Furthermore, default setting of the dynamic wallpaper is played video in full screen. Thus, when the video to be played is determined, the video is played in full screen. In one embodiment, the setting of the full screen may be changed, and it may be easily modified or changed for those skilled in the art.

When at least one of user's fingers touches the screen, the mobile system detects the positions and/or gestures to determine whether the user wants to execute a shrinking operation, expanding operation or a moving operation (Step S510). If the user wants to execute shrinking operation, a shrinking ratio is first calculated (step S512) and then the window the dynamic wallpaper is shrunk according to the shrinking ratio (step S514). If the user wants to execute an expanding operation, an expanding ratio is first calculated (step S518), then the window is expanded according to the expanding ratio (step S520) and the selected video is played in the expanded window (step S522). If the user wants to execute a moving operation, associated movement is first calculated (step S524), then the new window is moved according to the movement (step S526) and the selected video is played in the moved new window (step S528). Note that the steps S524 to S528 are executed after the dynamic wallpaper is shrunk.

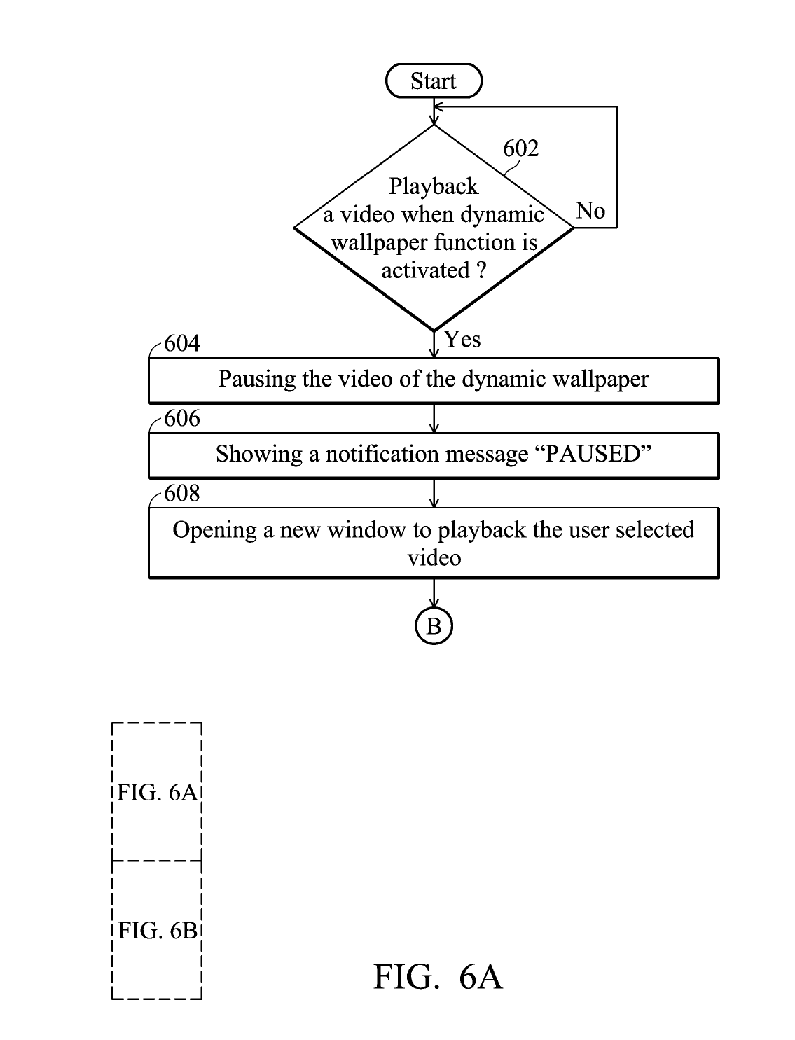

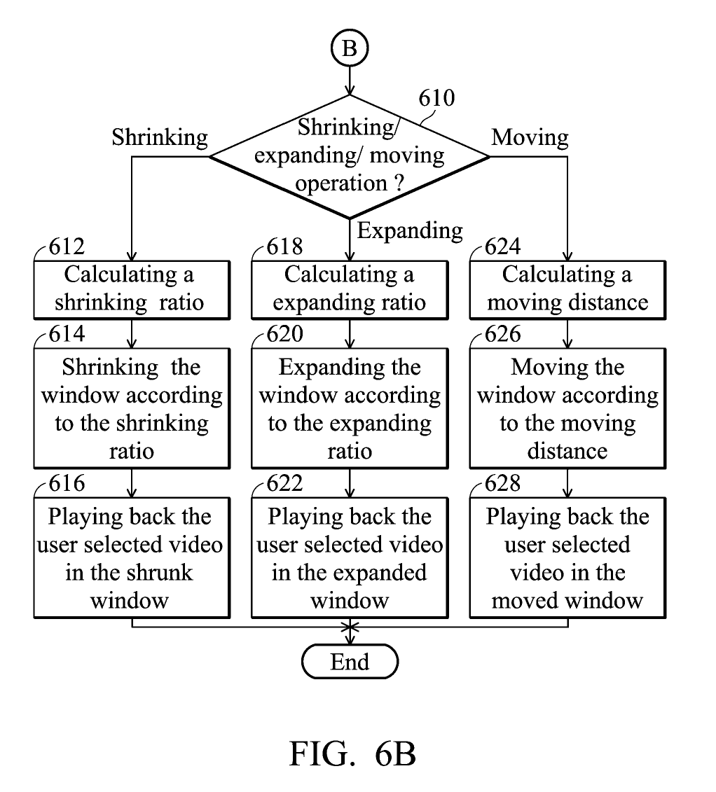

FIGS. 6A and 6B show a flow chart of a method for opening a new display window to play another video when the dynamic wallpaper is activated according to an embodiment of the invention. When the dynamic wallpaper function is executed and the user wants to play another video (step S602), the mobile system pauses the video of the dynamic wallpaper (step S604) and shows a notification message “PAUSED” to inform the user that the dynamic wallpaper has been paused (step S606). Then, a new display window is created to display the video the user wants to play (step S608). In one embodiment, the notification message “PAUSED” may be flashed to notify the user the dynamic wallpaper remains in pause state, which may be modified according to practical applications and the invention is not limited thereto. For example, the flash interval of the notification message “PAUSED” may be increased to reduce the affect on the user. In another example, the notification message “PAUSED” is shown but not flashed. Any person having ordinary skills in the art may modify, change or adjust the notify mechanism for the user. When the video selected by the user is played in the newly created display window, the mobile system detects whether user's fingers touch the screen or not. The mobile system detects the positions of the user's fingers and/or gestures to determine a next operation, such as shrinking, expanding or moving operation (step S610). If the user wants to execute a shrinking operation, a shrinking ratio is first calculated (step S612) and then the new display window is shrunk according to the shrinking ratio (step S614). If the user wants to execute expanding operation, an expanding ratio is first calculated (step S618) and then the new display window is expanded according to the expanding ratio (step S620). If the user wants to execute a moving operation, a movement is first calculated (step S624), then the new display window is moved according to the movement (step S626) and the user's selected video is played in the moved new window (step S628). Note that the invention introduces the shrinking, expanding or moving operation to a currently active window; therefore, when the user selects a new video for playback, the dynamic wallpaper does not respond to the operations because the new display window becomes the active window now, and these operations are applied to this new display window. When the user closes the new display window, the dynamic wallpaper is automatically resumed for video playback (the notification message will be withdrawn) and the user needs not input any recovery instruction or operation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for displaying a new video when a mobile device is playing a dynamic wallpaper, comprising:
pausing video playback of the dynamic wallpaper;
showing a notification message to inform a user that the video playback of the dynamic wallpaper has been paused; and
playing a selected video in a new display window, wherein the new display window is displayed on the dynamic wallpaper.

2. The method as claimed in claim 1, wherein audio associated with the video of the dynamic wallpaper is muted when the video of the dynamic wallpaper is displayed.

3. The method as claimed in claim 1, further comprising a step of shrinking the new display window when a shrinking operation is input during playback of the selected video.

4. The method as claimed in claim 3, wherein the shrinking step further comprises a step of calculating a shrinking ratio according to a gesture that the user inputs on a screen of the mobile device.

5. The method as claimed in claim 1, further comprising a step of expanding the new display window when an expanding operation is input during playback of the selected video.

6. The method as claimed in claim 5, wherein the expanding step further comprises a step of calculating an expanding ratio according to a gesture that the user

7. The method as claimed in claim 1, further comprising a step of moving the new display window according to a movement calculated according to a gesture that the user inputs on a screen of the mobile device.

8. A mobile system that is capable of playing a dynamic wallpaper, comprising:
a screen;
a non-volatile memory, storing control codes of the mobile system; and
a microprocessor, operating the control codes to execute the steps of:
playing a video selected by a user for playback as a dynamic wallpaper on the screen of the mobile system; and
muting audio associated with the selected video when the selected video is played as the dynamic wallpaper.

9. The mobile system as claimed in claim 8, wherein the dynamic wallpaper is displayed in full screen.

10. The mobile system as claimed in claim 8, wherein the microprocessor operates the control code to create a new display window for playing a new video on the dynamic wallpaper, and the video of the dynamic wallpaper is paused when the new video is played.

11. The mobile system as claimed in claim 10, wherein the microprocessor operates the control codes to show a notification message to inform the user that the video playback of the dynamic wallpaper has paused when the new video is played.

12. The mobile system as claimed in claim 10, wherein the microprocessor operates the control codes to resume the paused video playback of the dynamic

13. The mobile system as claimed in claim 10, wherein the microprocessor operates the control codes to calculate a shrinking ratio of the new display window according to a gesture that the user inputs on the screen of the mobile device.

14. The mobile system as claimed in claim 10, wherein the microprocessor operates the control codes to calculate an expanding ratio of the new display window according to a gesture that the user inputs on the screen of the mobile device.

15. The mobile system as claimed in claim 10, wherein the microprocessor operates the control codes to calculate a movement of the new display window according to a gesture that the user inputs on the screen of the mobile device.

16. A dynamic wallpaper displaying method for a mobile system, comprising:
selecting a video by a user; and
playing the video as a dynamic wallpaper of the mobile system,
wherein audio associated with the video is muted when the selected video is played as the dynamic wallpaper.

17. The method as claimed in claim 16, wherein the dynamic wallpaper is displayed in full screen of the mobile phone system.

18. The method as claimed in claim 16, wherein when the video selected by the user is lost, a default video of the mobile system is played as the dynamic wallpaper.

19. The method as claimed in claim 16, further comprising a method for opening a new display window for displaying a new video when the dynamic wallpaper is displayed, the method comprising:
pausing video playback of the dynamic wallpaper;
showing a notification message to inform the user that the video playback of playing a new video selected by the user in the new window, wherein the new window is displayed on the dynamic wallpaper.
